(19) United States
(12) Patent Application Publication
(10) Pub. No.: US 2026/0023351 A1
(43) Pub. Date: Jan. 22, 2026

(54) Autonomous Process Recipe Generation for Semiconductor Process Systems through Reinforcement Learning with Minimized Recipe Time

(71) Applicant: Yang Pan, SINGAPORE (SG)

(72) Inventor: Yang Pan, SINGAPORE (SG)

(73) Assignee: Inspiring Atoms Pte Ltd, SINGAPORE (SG)

(21) Appl. No.: 18/778,961

(22) Filed: Jul. 20, 2024

(51) Int. Cl. G05B 13/02; G05B 19/4099

(52) U.S. Cl. CPC G05B 13/0265; G05B 19/4099; G05B 2219/45031

(57) ABSTRACT

Disclosed is a system and method for a semiconductor process system utilizing reinforcement learning (RL) algorithms to generate optimized process recipes with minimized recipe times. This system includes a comprehensive digital twin, encompassing subsystem, chamber plasma, and process digital twins, and employs neural network models to enhance efficiency. By integrating a policy neural network with Monte Carlo Tree Search (MCTS), the system autonomously achieves an optimized trade-off in the process recipe.

### FIELD OF THE INVENTION

The present invention relates to the field of semiconductor manufacturing. More specifically, it pertains to methods and systems for autonomously generating process recipes for semiconductor processing systems, including etching and deposition processes. The invention employs advanced digital twin technology, reinforcement learning (RL), and neural networks to optimize process parameters, improve the efficiency and accuracy of semiconductor fabrication, and reduce manufacturing costs. This method focuses on achieving the minimized recipe time while still meeting stringent performance specifications.

### BACKGROUND

Semiconductor manufacturing is an intricate and highly demanding field, characterized by the need for precise control over a multitude of process parameters to ensure the quality and performance of the final products. As technology advances, the complexity of these processes increases, making it increasingly challenging to meet stringent performance requirements. Moreover, the industry is facing escalating costs, driven by the need for advanced equipment, materials, and the intensive trial-and-error methods traditionally used to develop process recipes.

A significant issue in semiconductor manufacturing is the difficulty in achieving the desired performance within the minimized recipe time. The current approach, which relies heavily on empirical methods, expert knowledge, and iterative testing, is not only time-consuming and labor-intensive but also often falls short of optimizing the process parameters to achieve both high performance and minimized recipe time.

Digital twin technology, which allows for the creation of virtual representations of physical systems, offers a potential solution by enabling detailed simulations and analysis. However, the integration of digital twins into the recipe generation process has been limited, and there remains a need for more advanced methods to handle the vast number of variables and their complex interactions.

RL, a branch of artificial intelligence (AI), presents a promising approach to autonomously optimize complex systems. By training neural networks to learn optimal policies through simulated interactions with a digital twin, RL can generate highly efficient and accurate process recipes. The RL process involves numerous learning cases conducted in the background, which allows for extensive exploration of the parameter space. This iterative learning mechanism enables the RL system to balance the need for high performance with the goal of minimizing recipe time. Incorporating techniques such as Monte Carlo Tree Search (MCTS) within the RL framework further enhances the balance between exploration and exploitation, leading to superior optimization results.

The present invention addresses these critical challenges by providing a comprehensive method and system for autonomously generating process recipes. This solution leverages the capabilities of a full digital twin, RL, and neural networks to optimize process parameters effectively. By conducting many learning cases in the background, the RL system continuously improves its policy neural network to achieve the best possible balance between performance and recipe time. This significantly reduces the reliance on traditional empirical methods, shortens development cycles, and enhances the overall efficiency and performance of semiconductor processing systems, all while controlling manufacturing costs. This invention is designed to meet the dual objectives of achieving the desired performance and minimizing the recipe time, thus providing a robust solution for modern semiconductor manufacturing needs.

### SUMMARY

In some embodiments, the present invention relates to an advanced method and system for autonomously generating process recipes for semiconductor processing systems, specifically for etching and deposition processes. This method leverages a comprehensive digital twin, including various subsystem digital twins such as RF, gas, temperature, chamber plasma, surface flux, and process digital twins. For computational efficiency, neural network versions of these digital twins are employed.

In certain implementations, the method utilizes a full digital twin of the process system, encompassing various subsystem digital twins. These subsystem digital twins simulate specific aspects of the process system, providing a detailed and accurate virtual representation. The inclusion of neural network versions of these digital twins enhances computational efficiency by replicating the behavior of the subsystem digital twins, thereby enabling faster and more efficient simulations.

In some embodiments, the invention employs an RL process for generating the process recipe. This process includes training a policy neural network and utilizing the MCTS algorithm. The policy neural network, comprising an input layer, a plurality of hidden layers, and an output layer, is responsible for generating probability distributions for selected process recipe parameters and step times. The output layer includes outputs describing softmax or logistic functions, which facilitate the generation of these probability distributions. The algorithm encourages more exploration, particularly for the step times, to thoroughly explore the parameter space and optimize the process recipe.

In certain embodiments, the RL process generates a total reward for each simulated process case. The total reward includes a first reward for performance and a second reward for recipe time. The second reward can be converted into the first reward using an exchange rate. The initial exchange rate is assigned by an AI engine and is progressively increased to focus the RL process more on minimizing the recipe time while still meeting output specifications. This progressive increase in the exchange rate ensures that the RL process becomes more robust over time, balancing the need for performance with the need to minimize recipe time.

In some implementations, the method is designed to be generic and applicable to both etching and deposition systems. The use of the full digital twin and the RL-based process recipe generation ensures that the method can be adapted for various semiconductor processing applications. The process begins with initiating the RL process, generating simulated process cases, and calculating rewards. The weights of the policy neural network are then updated based on the total reward until changes in weights are minimal. Subsequently, a process recipe is generated based on the updated policy neural network and is used for real-world processing of substrates.

In certain embodiments, the system components include an AI machine, comprising hardware and software modules optimized for AI applications. The AI machine includes an RL engine with an RL agent, a system digital twin, and an AI engine controller. The system digital twin integrates subsystem digital twins, some of which are trained neural networks, to simulate the entire process system accurately. This integration allows for a comprehensive and detailed simulation environment, which is essential for the accurate generation of process recipes.

Furthermore, in some implementations, the method includes establishing, by the AI engine, a node associated with a state and expanding the node into a network including a plurality of nodes consisting of a plurality of state-action pairs. The state describes the substrate being processed, and the action describes a step of the process recipe. An algorithm that encourages exploration rather than exploitation for the step times is employed while an action is being generated. This algorithm, which may include an E-greedy algorithm, ensures thorough exploration of the parameter space to achieve the optimal process recipe.

In certain embodiments, the process system includes an etching process system and a deposition process system. The trained policy neural network can result from more than one set of input and output specifications, allowing for a highly adaptable system. Since the training can be conducted in the background, a very large and deep neural network can be applied with a heavy data load. An atomic layer etching (ALE) is used to illustrate the inventive concept. This approach allows for the development of a generic ALE policy neural network for inputs with different types of stacks, critical dimensions, and profile requirements. The invention thus provides a broad spectrum of implementation, from a specialized policy neural network for a specific application to a more generic policy neural network for several or more applications.

The invention's approach to autonomous process recipe generation using a full digital twin and reinforcement learning with MCTS ensures efficient, accurate, and adaptive semiconductor processing, making it a robust solution for modern etching and deposition process systems. The RL process, through numerous learning cases conducted in the background, continually refines the process recipe to achieve the minimized recipe time while meeting stringent performance specifications, thus addressing the critical challenges of cost and efficiency in semiconductor manufacturing.

### BRIEF DESCRIPTION OF THE DRAWINGS AND TABLES

The following brief descriptions relate to the accompanying drawings, which serve to enhance the clarity and understanding of the present disclosure:

FIG. 1: Illustrates a diagram of an exemplary process system.

FIG. 2A: Depicts a functional diagram of an AI engine configured to autonomously generate a process recipe.

FIG. 2B: Provides a schematic representation of the detailed functional blocks of an AI machine comprising an AI engine.

FIG. 3: Presents a schematic representation of a system digital twin.

FIG. 4: Portrays a neural network representation for the system digital twin.

FIG. 5: Displays a process flow example using ALE, mapped for the RL processes.

FIG. 6: Shows a schematic representation of a policy neural network integral to the RL process.

FIG. 7: Reveals a schematic diagram of an exemplary algorithm for RL, utilizing an MCTS program to autonomously generate a process recipe.

FIG. 8: Illustrates a flowchart describing the generation of a process recipe through RL.

FIG. 9: Illustrates a flowchart describing a process for minimizing the recipe time.

Table 1: Outlines design parameters describing subsystem structures and topologies.

Table 2: Summarizes parameters that describe structures pre- and post-ALE processing.

### DETAILED DESCRIPTIONS

This section delves into the specific embodiments of the present invention, aiming to provide a comprehensive understanding. It is important to note that while certain implementations are described to illustrate the inventive aspects clearly, any alterations and modifications that fall within the scope of the appended claims are intended to be encompassed by this disclosure. These detailed descriptions underscore the innovative features of the invention, setting it apart from existing technologies.

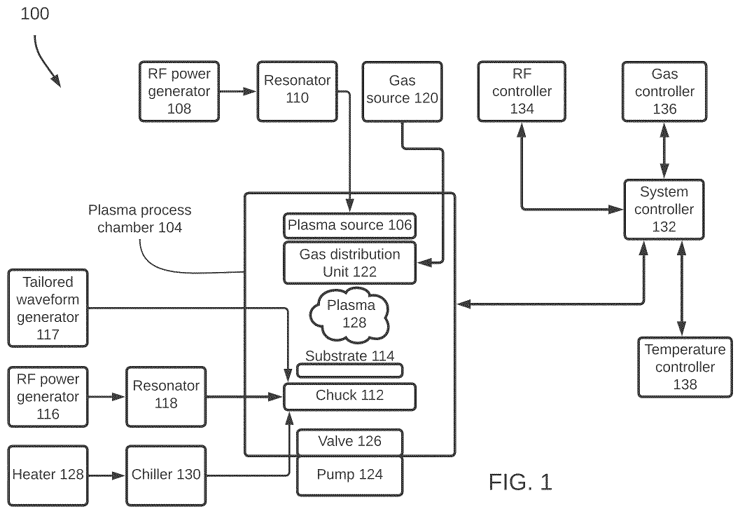

FIG. 1 illustrates an embodiment of a process system, designated as 100. The process system is generic for plasma-enhanced etching or deposition processes. For example, the process system 100 can be employed for reactive ion etching (RIE) or ALE. It can also be utilized for plasma-enhanced chemical vapor deposition (PECVD) or atomic layer deposition (ALD). In some cases, subsystems related to plasma generation may be absent, converting the process system 100 into a thermal process system. The inventive concept presented herein is generic and can be applied to any type of semiconductor process system. The plasma-based process system with a vacuum chamber is used for illustration only and should not limit the scope of the inventive concept. The process system 100 includes a plasma process chamber 104, constructed to maintain a vacuum suitable for plasma processing. Within this system, a plasma source 106 is situated to receive radio frequency (RF) power from an RF power generator 108 via a resonator 110. The plasma source 106 may be realized in various configurations, such as an inductively coupled plasma (ICP) source or a transformer coupled plasma (TCP) source, among others.

The RF power generator 108 can operate at single or multiple frequencies—for instance, 13.56 MHz, 2.0 MHz, and 40.0 MHz may be used. The role of the resonator 110 is to match the output impedance of the RF power generator 108 with the impedance of the plasma process chamber 104, considering the impedance characteristics of the transmission lines. This resonator 110 typically comprises inductors and capacitors and may include mechanically adjustable capacitors. Alternatively, in other embodiments, the resonator 110 might exclude mechanically adjustable capacitors.

Impedance adjustments may be realized by varying the operating frequencies of both the RF power generator 108 and the resonator 110. During a process, the plasma is likely to exhibit variable states, which present different impedance levels. To maintain efficient energy transfer and minimize power reflection from the plasma process chamber 104 back to the resonator 110, it may be necessary to fine-tune the frequency for each distinct state of the plasma to ensure the resonator 110 remains in a resonating condition.

The plasma process chamber 104 is further outfitted with a chuck 112 that supports a substrate 114. The chuck 112 can be designed as an electrostatic chuck (ESC) or a vacuum chuck, depending on the process requirements. When an ESC is utilized, the chuck 112 is electrically connected to an RF power generator 116 via a resonator 118. Like resonator 110, resonator 118 requires tuning to a resonating state by adjusting its operating frequency. The operating frequencies of RF power generator 116 may differ from those of RF power generator 108. For instance, generator 116 may operate at a substantially lower frequency than generator 108.

The RF power generator 116 provides a bias to the chuck 112. This bias is delivered through a blocking capacitor, which, while not depicted, is standard in the field. Alternatively, a tailored waveform generator 117 may be employed to supply a bias to the chuck 112. The tailored waveform can significantly narrow the distribution of ion energies, where the ions are produced by the ignition of plasma 128 within the process chamber 104. Depending on the implementation, the tailored waveform generator 117 may be connected to the chuck 112 alone or in conjunction with the RF power generator 116 and resonator 118 to provide the required bias.

The operation of the RF subsystem, including the RF power generators, resonators, and plasma source, is managed by an RF controller 134. This controller communicates with and is subordinate to a system controller 132.

The plasma process chamber 104 incorporates a gas distribution unit 122, tasked with delivering process gases from a gas source 120 into the chamber. The gas distribution unit 122 can take various forms, such as a gas injector or a showerhead, and may include a side injection feature near the inner surfaces of the chamber body. The gas source 120 typically draws from a facility's gas supply through a gasbox and uses a combination of valves, pressure regulators, and mass flow controllers (MFCs) to regulate the gas flow into the chamber. In some other implementations, precursor delivery systems for delivering a precursor in gas, liquid, or even in solid state may also be employed (not shown in the figure).

Additionally, the plasma process chamber 104 houses a pump 124, which may be a turbomolecular pump or another suitable type, designed to evacuate gases and by-products from the chamber. A valve 126, generally positioned atop the pump 124, modulates the evacuation rate from the chamber. The chamber pressure is monitored by a manometer (not illustrated), which triggers adjustments to the set point of an actuator of the valve 126 to maintain a constant pressure suitable for the vacuum-based plasma process.

The gas distribution subsystem, which includes the gas distribution unit 122, gas source 120, pump 124, and valve 126, is overseen by a gas controller 136. This controller is connected to the system controller 132, ensuring integrated management of the process system 100.

The plasma process chamber 104 is also equipped with a temperature control subsystem to maintain the desired thermal conditions for the substrate and the chamber. In the embodiment exemplified in FIG. 1, the temperature of the chuck 112 is regulated by a temperature controller 138, which operates a heater 128 and a chiller 130, as well as a temperature sensor (not depicted). The chuck 112 may be designed with multiple zones, each maintained at a distinct temperature. Additionally, temperature control for other components within the process chamber, such as the gas distribution unit 122 and various chamber surfaces, may be required and is implemented as is common in the industry. The temperature subsystem is controlled by a temperature controller 138 coupled to the system controller 132.

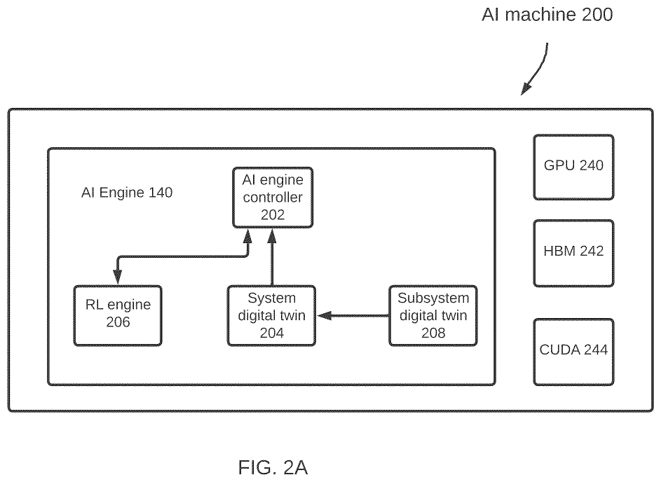

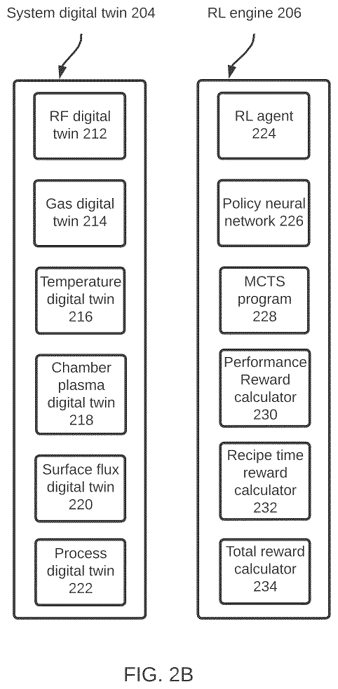

FIG. 2A showcases an embodiment of the AI machine 200. In one implementation, the AI machine is a computer optimized for AI applications through advanced hardware and software modules. The hardware module includes advanced chips like a graphics processing unit (GPU) 240 and high-bandwidth memory (HBM) 242. These components are integrated using advanced packaging technologies to achieve the very high bandwidth required for AI applications. The software module further includes compute unified device architecture (CUDA) 244. These hardware and software modules enable the AI machine 200 to conduct highly efficient parallel computing, such as the algorithms used for RL.

The AI machine 200 also includes an AI engine 140, which enables autonomous operations for training a policy neural network used to generate a process recipe. The AI engine 140 further comprises an AI engine controller 202, which controls operations of the AI engine. The AI engine controller 202 can be implemented leveraging the GPU 240, HBM 242, and CUDA 244. The AI engine 140 further includes an RL engine 206 responsible for autonomously generating a process recipe through RL by leveraging a system digital twin 204, which replicates the operations of the process system in a virtual environment. The system digital twin 204 includes various subsystem digital twins 208.

FIG. 2B depicts more detailed functional blocks of the AI engine 140. The system digital twin 204 comprises an RF digital twin 212 for simulating the operations of the RF subsystem, a gas digital twin 214 for the gas subsystem, and a temperature digital twin 216 for the temperature subsystem. The system digital twin 204 further comprises a chamber plasma digital twin 218, a surface flux digital twin 220, and a process digital twin 222.

The RL engine 206 further includes an RL agent 224, which is typically a software program stored in a storage medium of the AI engine controller 202 responsible for executing the RL process. A policy neural network 226 and an MCTS program 228 are employed by the RL agent 224 to build a search tree and to learn by evaluating actions against total rewards. The total rewards are calculated by a total reward calculator 234, which takes inputs from a performance reward calculator 230 and a recipe time reward calculator 232 for each completed simulated case using the system digital twin 204.

After completing a simulated process case using the actions generated from the policy neural network 226 and the MCTS program 228, the RL agent 224 calculates a first reward using the performance reward calculator 230. A cost function is constructed using a squared error function which measures the difference between generated and targeted output parameters for the substrate. Each of the terms in the squared error function is associated with a weight to reflect its relative importance. The RL agent 224 calculates a second reward using the recipe time reward calculator 232. The recipe time is a summation of each of the step times, which is defined as the duration of a process step. Both the first reward and the second reward can be exemplarily discretized into positive or negative integers. The second reward can be converted into the first reward using an exchange rate. A total reward can then be generated by the total reward calculator 234.

An initial exchange rate can be assigned by the RL agent 224 before starting the RL process. Subsequently, the exchange rate can be increased to focus the RL process more on minimizing the recipe time.

In one implementation, the AI machine 200 may be coupled to the system controller 132 through a communication link. In another implementation, the AI machine 200 may be coupled to multiple system controllers of a fleet of process systems. In yet another implementation, the AI engine 140 can be a part of a system controller.

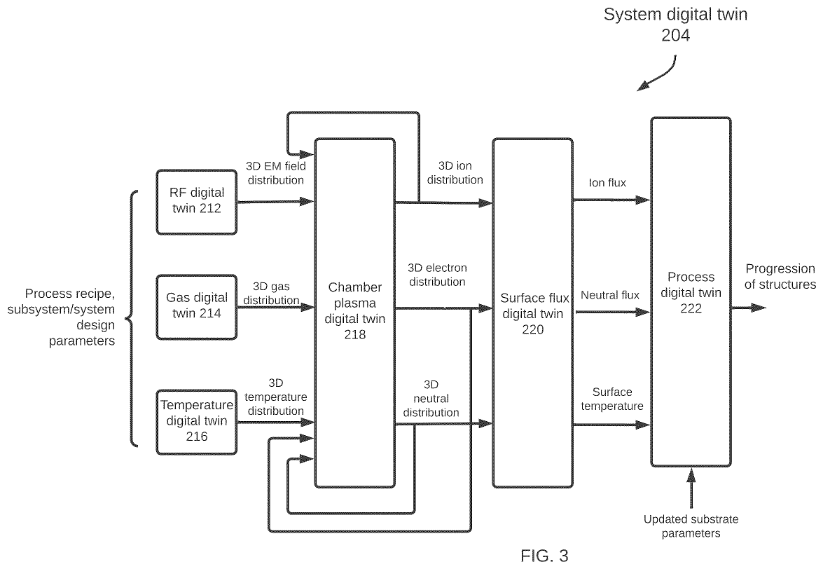

FIG. 3 illustrates schematically a flow diagram of the system digital twin 204. The RF digital twin 212, the gas digital twin 214, and the temperature digital twin 216 take related process recipe parameters and subsystem and system design parameters as their inputs. The RF digital twin 212 is designed to simulate the RF subsystem, which includes at least RF power generators and resonators. In some cases, it may also include a tailored waveform generator for the bias, although the tailored waveform generator is typically not operated in the RF range. In one implementation, the RF digital twin 212 includes a SPICE model for the RF circuits, which determines the RF power deposited into the plasma source during a time step. A Maxwell's equation solver is subsequently employed to compute the electromagnetic (EM) field distribution inside the chamber, considering the chamber structure parameters.

The RF digital twin 212 receives recipe parameters like RF power and initial operating frequency for the step. A set of system and subsystem design parameters, such as RF circuit topology, values of each component, structures, and parameters of the plasma source, and chamber structure parameters, are typically stored in a storage medium of the AI engine controller 202. A set of exemplary design parameters for the RF subsystem is listed in Table 1. The RF digital twin 212 can be used to determine the resonating frequencies of the RF subsystems. In another embodiment, more than one RF digital twin may be used. For example, the plasma source and the chuck bias may be modeled by different RF digital twins.

Similarly, the gas digital twin 214 replicates functions of the gas subsystem, encompassing elements like the gas source 120, the gas distribution unit 122, the pump 124, the valve 126, and the manometer (not pictured). The gas digital twin 214 receives process recipe parameters like the flow rates of process gases. For example, for an ALE process, the gas digital twin 214 receives the flow rate for the first and second process gases and the chamber pressures for the surface modification step and the sputtering step, respectively. The design parameters for the gas delivery systems include the design parameters for the gas distribution unit as listed exemplarily in Table 1. If it is a showerhead, the design parameters will include its size, volume, distribution of injection channels/holes, and their sizes. The shape and size of the plasma process chamber are also important input parameters for the gas digital twin 214. The output of the gas digital twin 214 includes three-dimensional (3D) gas distribution (e.g., density, partial pressure, velocity, and residence time) inside the gas distribution unit 122 and in the plasma process chamber 104. In some implementations, the gas distribution along gas lines from the gas source 120 to the entry of the gas distribution unit 122 will also be modeled. The gas distribution can be simulated using methods based on fluid dynamics by leveraging finite element techniques or other advanced computational techniques.

The temperature digital twin 216 mirrors the temperature subsystem, which includes the heater 128, the chiller 130, and temperature sensors (not pictured). Besides the chuck temperature controls, it may additionally incorporate temperature regulation for other chamber parts such as the gas distribution unit 122. The temperature digital twin 216 receives process recipe parameters like chuck temperatures. In some cases, the chuck 112 may be divided into zones, each with a different temperature specified by a process recipe. The input parameters to the temperature digital twin 216 further include design parameters for the heater and chiller as shown exemplarily in Table 1. For the heater 128, the design parameters include its locations inside the chuck or other chamber parts, as well as a range of its operating power. The design parameters further include thermal conductivity for various materials and their interfaces. For the chiller, the design parameters may include the type of coolants, flow rates of the coolants, and the number and locations of conduction channels. An example is also depicted in Table 1. The temperature digital twin may apply numerical simulation methods like the finite element method to simulate the temperature distribution of the chuck, substrate surface, and inner surface of the plasma process chambers.

It should be noted that treating the digital twins 212, 214, and 216 independently may oversimplify the real world. For example, the RF power deposited into the chamber may affect the temperature of the substrate surface. Some of these interactions among different subsystem digital twins should be considered carefully.

The outputs of the subsystem digital twins feed into the chamber plasma digital twin 218. During a specific time step of a process, the chamber plasma digital twin 218 models the plasma inside the chamber 104 and outputs 3D distributions of electrons, ions, and neutrals. The distributions at a specific time are a function of the EM field, gas, and temperature at that moment, as well as the distributions of electrons, ions, and neutrals prior to that moment. Therefore, the distributions of the electrons, ions, and neutrals need to be determined in a recurring manner. As shown in FIG. 3, the outputs of the chamber plasma digital twin from the current time step can serve as inputs for the same digital twin for the next time step. Each simulation event is for a predetermined time step defined by the AI engine controller 202.

After the 3D distributions of ions and neutrals are known, the surface flux digital twin 220 calculates and outputs the ion flux and neutral flux toward the surface of the substrate. Additionally, the digital twin 220 may output the surface temperature of the substrate by working together with the temperature digital twin 216. The plasma sheath above the substrate is critically important for determining the ion flux, which greatly impacts the etching behavior. The formation of the plasma sheath is well understood in the art and can be modeled accurately using the chamber plasma digital twin 218.

The outputs of the surface flux digital twin 220 feed into the process digital twin 222 to simulate the process in the plasma process chamber 104. The updated substrate parameters or its state serves as the inputs to the process digital twin 222. The current state of the substrate parameters is used by the process digital twin 222 to determine its outputs. The flow depicted in FIG. 3 represents a snapshot of the process during the time step in the plasma process chamber 104. Therefore, the output of the process digital twin is a progression of the structures during the time step.

During each time step, the accumulated ion and neutral fluxes should be counted. Details of ion and neutral distribution are important for the process in the plasma process chamber 104. For ions, their energy and angular distributions during the step are critically important and can vary based on location on the surface of the substrate. The outputs of the surface flux digital twin 220 should include such critical details. Similarly, for neutrals, the density, thermal energy, and activation energy are important parameters for the substrate surface undergoing the process. It should be noted that the designs of the RF, gas, temperature, chamber plasma, surface flux, and the process digital twins are exemplary herein. There could be many variations in implementation strategies. In some implementations, the chamber plasma digital twin and the surface flux digital twin could be combined into a single digital twin. In other implementations, the surface flux digital twin may be combined with the process digital twin. Additionally, the RF subsystem digital twin may be broken down into several digital twins to represent the plasma source and the bias units separately. Similarly, the temperature digital twin can be divided into two or more digital twins, with at least dedicated digital twins for the chuck and the gas distribution unit, respectively. All such variations are obvious and should fall within the inventive concept of the present inventions.

Implementations of the digital twins by neural networks can follow the same strategy of dividing the process system into subsystems.

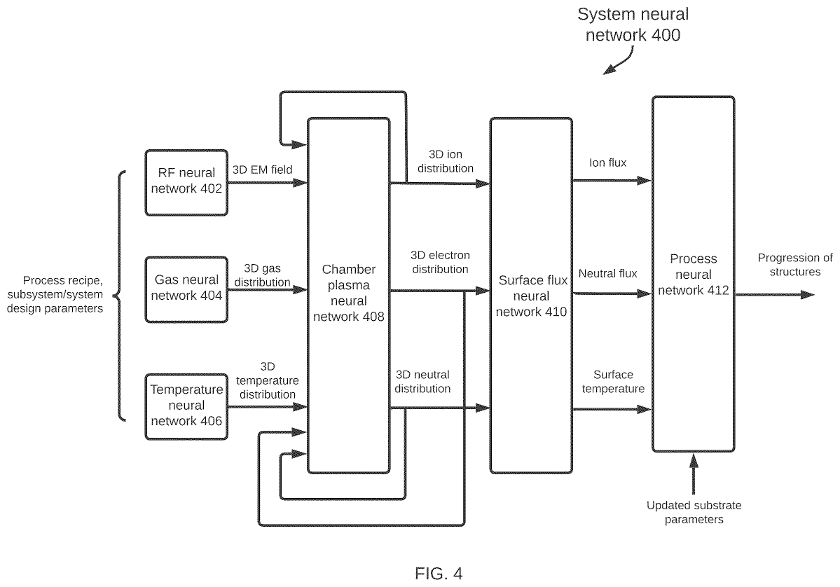

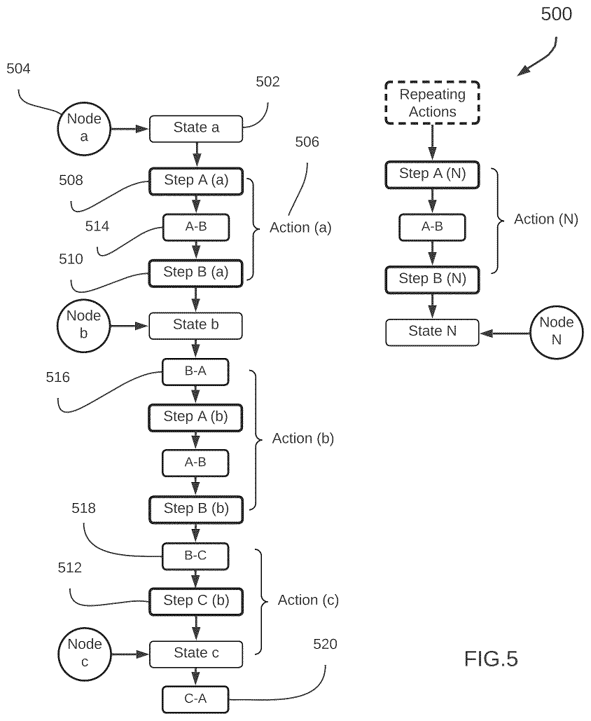

FIG. 4 illustrates an exemplary process system represented as a system neural network 400. In this embodiment, the subsystem digital twins are reconstructed using various neural networks. The RF digital twin 212 serves as the basis for training the RF neural network 402. Using the plasma source 106 attached to the RF power generator 108 and the resonator 110 as an example, one can begin by constructing a SPICE model to simulate the RF power generator 108 and resonator 110, including transmission line effects. The SPICE model outputs an initial AC current and voltage for coils of the plasma source 106, necessitating an assumed initial impedance for the plasma 128. Following this, a numerical simulator applies Maxwell's equations to predict the EM field distribution within the plasma process chamber 104.

The wealth of simulation data generated by the RF digital twin 212 becomes the training set for the RF neural network 402. The inputs for the neural network 402 include RF circuit topology and parameters such as the values of the inductors, capacitors, resistors, and transistors within the generator and resonator, along with detailed modeling of effects and transmission lines. Furthermore, the RF neural network 402 considers the chamber structure parameters dimensional specifics, positions of the chuck and the gas distribution unit, and material properties of these components, as listed exemplarily in Table 1. Some parameters are measurable and thus provide a more substantial weight during the training of the RF neural network 402. For instance, sensors might track the current and voltage alterations in the coils of the plasma source or the reflected power at the resonator's output node. A B-dot sensor with multiple small coils could be positioned within the chamber to map the magnetic field distribution in an experimental setup. The information gleaned from these sensors not only informs the training process but ensures that the RF neural network 402 is closely aligned with the real-world behaviors observed.

Utilizing a neural network for modeling the bias portion of the RF subsystem focuses on the electric field generated initially in response to the applied RF power. Unlike the magnetic field concerned with plasma generation, the bias deals with the electric field affecting the substrate surface.

Transitioning to the gas dynamics within the process system 100, we approach the gas distribution neural network 404, which is informed by the gas digital twin 214. Numerical algorithms based on fluid dynamics are the foundation for determining the gas distribution within the chamber 104. This complex interplay involves the gas inflow from the gas distribution unit 122, the outflow managed by the pump 124 and the valve 126, which is influenced by the chamber's conductance and volumetric parameters. While numerical simulations offer accuracy, their demand for computational resources and time constraints necessitate a more efficient approach for real-time applications, hence the establishment of the gas distribution neural network 404.

The gas distribution neural network 404 is trained with simulation data reflecting various parameters, including the types and flow rates of gases, the design of the gas distribution unit 122, the pump's capacity 124, and the set point of the actuator of the valve 126, along with chamber dimensions and conductance. Some of the design parameters are listed in Table 1. The gas distribution unit 122, implemented as an injector, a showerhead, or a combination of both, can affect the gas distribution in the process chamber 104. The size, quantity, and distribution of channels/holes inside the injector and the showerhead are important design parameters. Gas pressure within the process chamber, monitored by a manometer, provides measurement data that enhances the training of the gas distribution neural network 404, often weighted more significantly than the simulation data to ensure the model's relevance to actual conditions.

Parallel to these developments is the creation of the temperature neural network 406, drawn from the temperature digital twin 216. This neural network is dedicated to mapping the thermal landscape within the plasma process chamber, particularly at the substrate surface. Its training originates from numerical models that simulate heat interactions and distributions. Inputs for the temperature neural network 406 include chuck and chamber parameters affecting heat generation and thermal conduction. In scenarios involving an ESC, the thermal characteristics of the ESC and the heat conduction efficiency, potentially affected by helium pressure used as a medium, are critical. Additional chamber specifications, such as size and construction materials, also influence the model. Temperature readings from sensors within the chuck 112 and the chamber 104 provide valuable real-world data, which, when used to train the temperature neural network 406, may carry heavier weights over simulated data due to their direct measurement of the physical environment. This balance of simulated and measured data ensures that the various neural networks closely mimic the actual processes, thereby enabling accurate predictions within the process system.

FIG. 4 elucidates the intricacies of the system neural network 400, where the outputs of the RF, gas and temperature neural networks act as inputs to the chamber plasma neural network 408. The chamber plasma digital twin 218 serves as the foundation for the chamber plasma neural network 408, enabling a sophisticated representation of the plasma within the etching chamber. To simulate the movement of particles within the plasma, either a Monte Carlo or a numeric plasma simulator can be used to visualize the three-dimensional distribution of electrons, ions, and neutrals. This is crucial because electrons, which are significantly lighter, move more rapidly than ions, leading to the creation of a sheath on the surfaces within the chamber. This sheath plays a pivotal role in ion acceleration toward the substrate, a process essential for sputtering but potentially counterproductive during surface modification.

The training of the chamber plasma neural network 408 integrates simulation data for faster computation and higher efficiency. However, to refine its predictive capabilities, it may also assimilate measurement data gathered from sensors within the chamber, such as optical emission spectroscopy and hairpin sensors that gauge electron density. This measurement data may be given a heavier weight over the simulated data to ensure that the outputs of the plasma neural network 408 are as realistic as possible.

The dynamic nature of the plasma environment is captured by the recurrent neural network (RNN) design of the chamber plasma neural network 408. This means it can process temporal sequences, taking snapshots of plasma conditions at a given time and incorporating them into the model for future predictions. It is an ongoing cycle where the neural network's previous outputs become part of the input data for the next time step, mimicking the continuous evolution of the plasma state.

Once the chamber plasma neural network 408 has computed the 3D distributions, the ion and neutral fluxes to the substrate surface can be determined based on a surface flux neural network 410. The ion and neutral fluxes, along with the surface temperature of the substrate, are then taken as inputs for the process neural network 412. The process neural network 412 can be trained based on the data generated by the process digital twin 222. The outputs of the process neural network 412 further include the progression of the structures in the substrate.

Ultimately, the chamber plasma neural network 408 and the surface flux neural network 410 yield valuable outputs beyond just fluxes; they also provide critical insights into the surface temperature by working together with the temperature neural network 406. The accumulated fluxes during the time steps should also include valuable information about ion energy and angular distribution, as well as neutral thermal energy and activation energy. These parameters are essential for fine-tuning the process in the plasma chamber to achieve the desired etching precision and substrate surface quality.

It should be noted that FIG. 4 showcases an embodiment 400 of a full neural network implementation of the system digital twin 204. In other embodiments or implementations, some functional blocks may not be implemented as neural networks. For example, the surface flux neural network 410 may be an analytical model. Hence, embodiment 400 is exemplary. There may be many variants of implementations by combining models, lookup tables, analytical models, numerical models, and Monte Carlo models for selected building blocks of the system digital twin 204. All such variants fall within the scope of the present inventive concept An ALE process is employed herein as an example to illustrate a system and method for autonomously generating a process recipe through the execution of an RL process. FIG. 5 illustrates an ALE process flow 500, which is suitable for implementing the RL. An exemplary ALE process typically involves alternating between a surface modification step A and a sputtering step B in a cyclic manner. It should be noted that steps A and B herein are commonly called half cycles of the ALE process, which are different from the time steps we discussed previously for simulating plasma behavior in the chamber. The time steps are significantly shorter than step A and step B of the ALE process.

During step A, the surface of the substrate 114 is chemically altered using chemically active neutrals formed in the plasma, which is generated by a plasma source powered by an RF power generator. A halogen gas, such as chlorine, is often introduced to produce neutrals for this purpose. During this surface modification step, the bias to the chuck is typically set to zero to minimize the impact of ions on the substrate, thereby preserving the integrity of the ALE process.

Conversely, during the sputtering step B, an inert gas like argon is introduced to generate energetic ions that physically remove the chemically modified layer from the substrate by sputtering. At this juncture, a bias is typically applied to the chuck through the RF power generator and resonator.

Between steps A and B, a transitioning step 514 is employed to change the gases from step A (508) to step B (510). Similarly, between steps B and A, a transitioning step 516 is used to switch the gases from step B (510) to step A (508). Step A (a) shown in FIG. 5 represents step A at node a. Similarly, step B (a) represents step B at node a.

In some applications, particularly when etching high aspect ratio structures, an additional deposition step C (512) can be optionally included along with steps A and B. This step C is strategically inserted into the ALE cycle sequence but at a less frequent rate compared to steps A and B. Its primary function is to protect the sidewalls of the etched structures, thus preventing lateral etching that may arise due to the angular distribution of the ions. Before step C is executed, a transitioning step 518 is inserted to switch the gases for the step C. Similarly, after step C is completed, a transitioning step 520 is applied to switch the gases to step A. Step C (b) represents step C, at node b.

In the context of the present invention, it is important to map out all the steps and associated step times. The recipe time is a summation of all step times. The recipe parameters and the step times will need to be co-optimized through the RL process.

An ALE process runs in cycles, with each cycle including at least a step A and a step B. As shown in FIG. 5, an ALE cycle starts from a state and completes in a new state. A state is denoted as 502, which describes the substrate undergoing processing. State a represents the state at node a. Specifically, in an ALE process, the state describes one or multiple structures in the substrate. The description of the state includes, but is not limited to, parameters describing a structure being etched, such as depth, critical dimensions, profiles, and loadings as shown exemplarily in Table 2. The state 502 is associated with a node 504. Hence, state a is associated with node a. The ALE cycle starts initially at a node with a state, executes an action, denoted as 506, by selecting process recipe parameters using the policy neural network 226 and MCTS program 228, and completes at the new node with an updated state. In FIG. 5, Action (a) denotes the action triggered by the ALE recipe at node a.

It should be noted that a node can lead to more than one node through different actions. If the recipe parameters are continuous, the available new nodes would be infinite. Conversely, if the recipe parameters are discretized to limited levels, the available new nodes will be limited. A complete ALE cycle is used for an action in FIG. 5 as an example only. In some other implementations, a half cycle can be employed to separate the nodes. In such a case, the action is either a surface modification step A, a sputtering step B, or even a deposition step C. All such variations will fall within the scope of the present inventive concept.

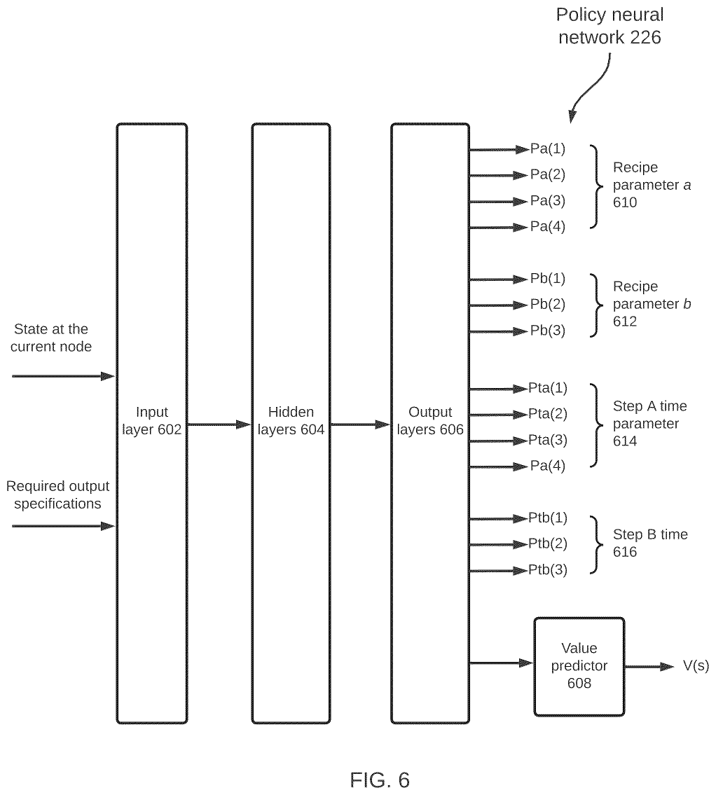

FIG. 6 showcases an exemplary policy neural network 226. The ALE process is used herein as an example only. The network 226 comprises an input layer 602 for receiving the state of the current node and required output specifications as its inputs. It should also be noted that the output specifications herein are final requirements after completion of the entire process, not a step of the process. Inclusion of the output specifications as one of the inputs of the policy neural network 226 makes it more generic and able to deal with changes in output specifications. In some other implementations, the inputs include only the state.

The policy neural network 226 further includes one or more hidden layers, denoted as 604, for processing received data from the input layer 602. The policy neural network 226 further comprises an output layer 608 which may include multiple parts, each part further including several parameters describing softmax or logistic functions.

Some of the parts are used for recipe parameters, exemplarily shown in FIGS. 6 as 610 and 612 for recipe parameters a and b, respectively. Two parameters are used for illustration only. Many more recipe parameters can be included. Pₐ(1), Pₐ(2), Pₐ(3), and Pₐ(4) are probability distributions for the parameter a with four discretized levels. P_{b}(1), P_{b}(2), and P_{b}(3) are probability distributions for the parameter b with three discretized levels.

Some other parts are employed for step times, exemplarily depicted in FIGS. 6 as 614 and 616. Two parameters are used for illustration only. All step times, including all step times for the transitioning steps, should be included. Pₜₐ(1), Pₜₐ(2), Pₜₐ(3), and Pₜₐ(4) are probability distributions for the step A time with four discretized levels. P_{tb}(1), P_{tb}(2), and P_{tb}(3) are probability distributions for the step B time with three discretized levels.

The outputs for the policy neural network 226 may not be the probability distribution directly. The parameters for the softmax and logistic functions may be the outputs, and the probability distributions can be calculated based on the output parameters accordingly.

In some implementations, the inclusion of step C may be modeled by a two-level discrete parameter for a logistic function, which is not shown in FIG. 6.

Furthermore, the output layer includes a value predictor 608 for predicting the value of the state based on the current policy represented by the policy neural network with the current weights. The output value is represented by V(s), where Vis the value, and s is the current state.

In some other implementations, different sets of ALE recipe parameters may be selected, and different levels may be selected for each parameter. If the process system 100 is employed for a different type of process like deposition, the parameter selection may also be different. The example herein is for illustration purposes and should not be considered a limit for the inventive concept. Furthermore, the selection of the recipe parameters and levels may be dynamic. This means they may be modified during the execution of an RL process. In one implementation, after a predetermined number of simulated cases are executed, the RL agent 224 may decide to narrow down the parameter space and adjust ranges and levels of the parameters to accelerate the convergence of the RL algorithm. In some implementations, old parameters may be abandoned, and new parameters may be initiated. In still other implementations, the entire set of recipe parameters may be selected and determined through the execution of the RL algorithm. The ranges of the parameters are related to subsystem capability and capacity and are stored in the storage medium of the AI engine controller 202 of the AI machine 200.

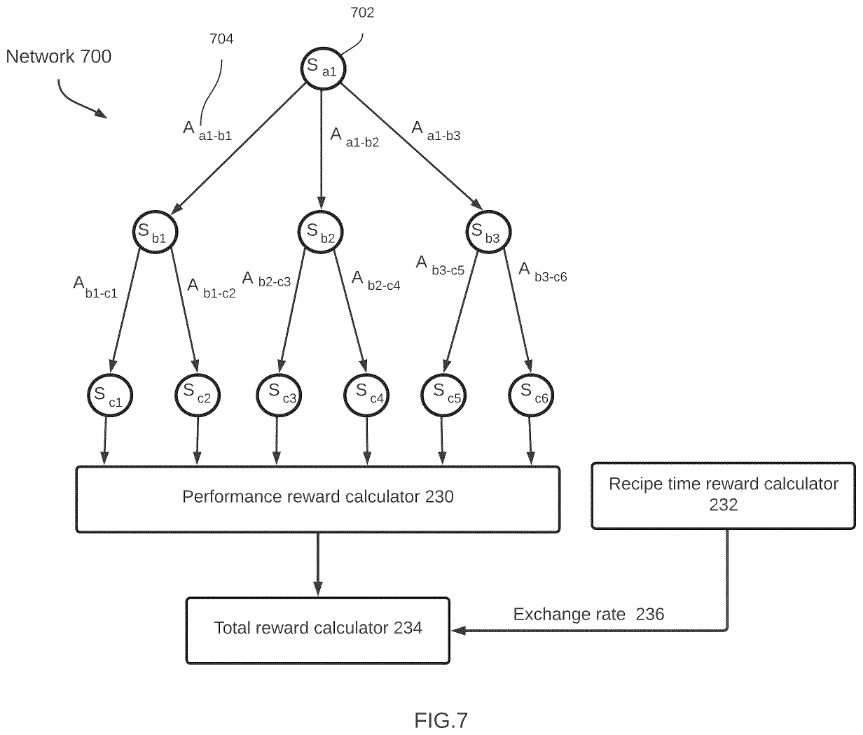

FIG. 7 schematically reveals a network 700 resulting from the RL process being rolled out through executing the MCTS program. As shown in FIG. 7, nodes, like node 702 are represented by circles. Each node is associated with a state, such as Sₐ₁. A parent node can lead to multiple child nodes upon the execution of actions such as 704. For example, the node with the state Sₐ₁ can transit into a node with the state S_{b1}, resulting from the action A_{g1-b1}. The RL agent 224 manages the selection process through the policy neural network 226 and the MCTS program 228. For the ALE process, each action represents one ALE cycle with selected process recipe parameters although a half cycle could also be an option. The selection of an action continues until reaching a terminal state where criteria are met to calculate a total reward by reward calculators 230/232/234. For example, in the case of an ALE process, the reward may be calculated when a specific etching depth is reached.

In the context of the present invention, a reward system is designed to take account of a first reward from performance of the substrate because of the virtual processing and a second reward from the recipe time. The second reward can be converted into the first reward through an exchange rate. A total reward can then be computed after the conversion. An initial exchange rate can be assigned by the RL agent 224. The exchange rate can be increased progressively when a new episode is started, which allows the RL process to be focused more on minimizing the recipe time.

A reward can be designed based on a cost function. A cost function for a process case is typically formulated as a summation of squared error functions pertaining to each output parameter of the structure post the virtual processing. The cost function can be defined as:

$$c = {\sum }_{i = 1}^{N} {{w}_{i} ( {p}_{i} - {p}_{itarget} )}^{2} , \qquad [ 1 ]$$

where c is the cost, wᵢ is the weight, and pᵢ is a normalized output parameter like critical dimension at a selected vertical coordinate for an ALE process, p_{itarget} is the normalized target value of the output parameter, and N is serial number of the parameter. If multiple structures are evaluated, the cost function can be further expressed as:

$$C = {\sum }_{j = 1}^{M} {W}_{j} {c}_{j} , \qquad [ 2 ]$$

where C is the accumulated cost across multiple structures, Wⱼ is the weight, and cⱼ is the cost for one of the structures. The method can take several or many structures across a substrate like a 300 mm wafer. The method can further take different structures or different parts of the structure to quantify various loading effects. The first reward can then be designed as:

$${R}_{1} = {f}_{1} ( c ) , \qquad [ 3 ]$$

Where R₁ is the first reward, and f₁ is a function for determining the first reward based on the cost c. In one implementation, the first reward R₁ may be designed as multiple, or many discrete numbers based on the cost. For example, the range of the cost can be divided into 10 intervals. Each interval is represented by an integer.

The second reward can be expressed as:

$${R}_{2} = {f}_{2} ( {\sum }_{k = 1}^{N} {t}_{k} ) , \qquad [ 4 ]$$

Where R₂ is the second reward, f₂ is a function for determining the second reward based on the summation of the step times. N is the number of the steps and tₖ is the step time for the step k. The total reward can then be written as:

$${R}_{total} = {R}_{1} + E \times {R}_{2} \qquad [ 5 ]$$

Where E is an exchange rate.

In another implementation, the cost function described by the Equation [1] may include an additional term which is a summation of products of squared function of the normalized step time and its weight. The RL process will optimize the cost function which includes both effects of the output structure parameters and the step times. The weights can be used to adjust relative importance of each parameter. Furthermore, the weights for the step times can be increased progressively in attempts to minimizing the recipe time while still meeting the output specifications for the structure parameters.

Each state-action pair like (Sₐ₁, A_{a1-b1}), which is a part of state-action chain for the test case receives the total reward. A visit count for the pair will also be updated. After enough test cases are executed and an episode is completed, the average reward associated with each state-action pair can be calculated as the accumulated reward divided by the visit count.

The value associated with a node can then be calculated by averaging the reward across all state-action pairs originating from the node. These data can be employed to train the policy neural network 226 to be more focused on generating actions with higher rewards.

In some implementations, the RL algorithm can be designed to be biased toward exploration rather than exploitation. For example, in a new episode for RL, the initial weights for the policy neural network can be assigned randomly. This can be a useful technique to prevent the RL process from being trapped in a local optimal point in the process recipe parameter space.

In other implementations, techniques like the ε-greedy algorithm may be employed to expand the search tree. The algorithm allocates a part of the probability distribution to a completely random distribution and is well known in the art.

In some implementations, the techniques for encouraging exploration than the exploitation can be specifically applied to step times to explore the parameter space thoroughly to achieve minimized recipe time while still meeting the output specifications for the structure parameters. The ALE example provided is for illustration only. For a typical RL process, the number of nodes could be substantial. The weights will be updated continuously to narrow down the selection of actions until the policy neural network 226 becomes deterministic. Subsequently, a process recipe can be generated for real-world applications.

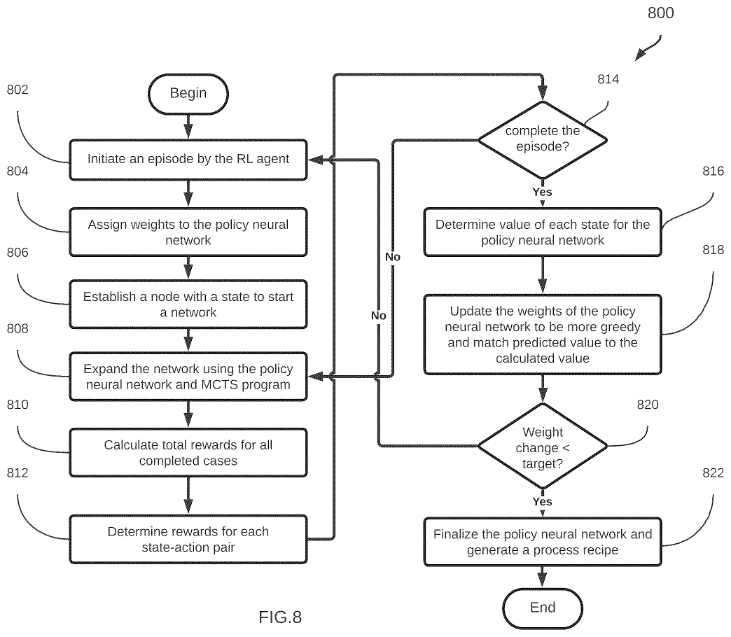

FIG. 8 showcases a flowchart for a process 800, which is a self-initiated process for autonomously generating a process recipe through the RL process. Process 800 starts with step 802, where the RL agent 224 initiates an episode for the RL process. An episode is represented by a network consisting of many nodes created by the MCTS program 228 enabled by the policy neural network 226. Each episode comprises many cases, wherein each case represents a completed simulation for a virtual process based on the system digital twin 204. For example, a case for an ALE process leads to a completed ALE process reaching the terminal state. The structures on the substrate have met a set of criteria, such as reaching the targeted etching depth. This typically includes a chain of actions and several or many intermediate states. A completed episode should deliver the total rewards associated with state-action pairs and the value of the nodes, wherein the total reward includes the effects of the structure parameters and the recipe time.

In step 804, initial weights are assigned to the policy neural network 226. In one implementation, the weights are assigned randomly. In another implementation, the weights are based on a previous RL episode, enabling continuous improvement, which makes the policy neural network 226 generate more optimal actions to increase the reward.

In step 806, an initial node for a network is established. The initial node is associated with an initial state, which describes an incoming substrate with a set of parameters as listed exemplarily in Table 2. At this point in time, the RL agent 224 applies the policy neural network 226 to generate probability distributions of selected recipe parameters and selected step times. Based on the probability distributions, the MCTS program 228 is employed to generate an action with determined recipe parameters and the associated step times. A random number generator is typically applied based on the distribution to generate the action. Subsequently, the RL agent 224 applies the action by leveraging the system digital twin 204 to generate the next node with a new state. The process repeats until a case is completed.

In step 808, the network is expanded progressively using the policy neural network 226 and the MCTS program 228. Each state-action pair of the network is associated with a visit count. Some state-action pairs are involved in more than one case, which is accounted for by the visit count.

In step 810, the first reward is calculated based on the performance reward calculator 230, and the second reward is calculated based on the recipe time reward generator 232. The total reward is calculated using the total reward calculator 234 by leveraging the first and the second rewards as well as the exchange rate.

If the state-action pair is involved in a specific case, it will receive the total reward accordingly in step 812. The reward accumulates as the visit count increases. The average reward for a specific state-action pair is the accumulated rewards divided by the visit count of the state-action pair.

In step 814, the RL agent 224 evaluates if the episode is completed. A decision may be made by evaluating nodes in the network and completed cases against selected recipe parameters, step times and total number of discrete levels. If the result is negative, the RL agent 224 continues to expand the network. Otherwise, the RL agent 224 determines the value for each state in step 816. For each node associated with the state, the RL agent 224 has established relationships between state-action pairs and their associated rewards. The value of the node based on the current policy can also be computed as the average of the total rewards across all the state-action pairs originating from the node.

In step 818, the RL agent 224 updates the weights of the policy neural network 226 based on all available state-action pairs. At each node, the state is an input for the policy neural network 226, and a set of softmax/logistic function parameters are the outputs. The output also includes the predicted value. The updated weights should make the policy neural network 226 more focused on generating actions with higher value and predicting the value more accurately. As the policy neural network 226 improves, it should become more deterministic in selecting an action from a group of available actions to generate the highest reward. This becomes a typical classification problem, hence a cost function for updating the policy neural network 226 should include a cross-entropy loss function and a squared error function for the value. The policy neural network 226 can be trained by leveraging rewards associated with all actions from the node. In one implementation, the earlier nodes may carry heavier weight during training to be consistent with a discount rule.

In step 820, the RL agent 224 evaluates whether the weights have converged to give a deterministic policy neural network. This can be done by summation of normalized weight changes and comparing the sum to a target. If the result is negative, the RL agent 224 can initiate a new episode to repeat the process and generate more data through further exploration. In one implementation, an e-greedy algorithm may be employed to encourage exploration over exploitation. In another implementation, a new set of initial weights for the policy neural network 226 may be applied. In yet another implementation, the weights generated from the previous episode may be used together with the ε-greedy algorithm. The ε-greedy algorithm may be specifically applied to generate selected step times to encourage more exploration.

If the evaluation in step 820 is positive, the policy neural network 226 is finalized in step 822. A process recipe can be generated accordingly. The finalized policy neural network 226 can be transmitted to the system controller 232.

The trained policy neural network 226 can result from more than one set of input and output specifications. Since the training can be conducted in the background, a very large and deep neural network can be applied with a heavy data load. A generic ALE policy neural network for inputs with different types of stacks and critical dimensions and profile requirements is possible. There will be a broad spectrum of implementation, from a specialized policy neural network for a specific application to a more generic policy neural network for several or more applications. All such variations will fall within the inventive concept of the present invention.

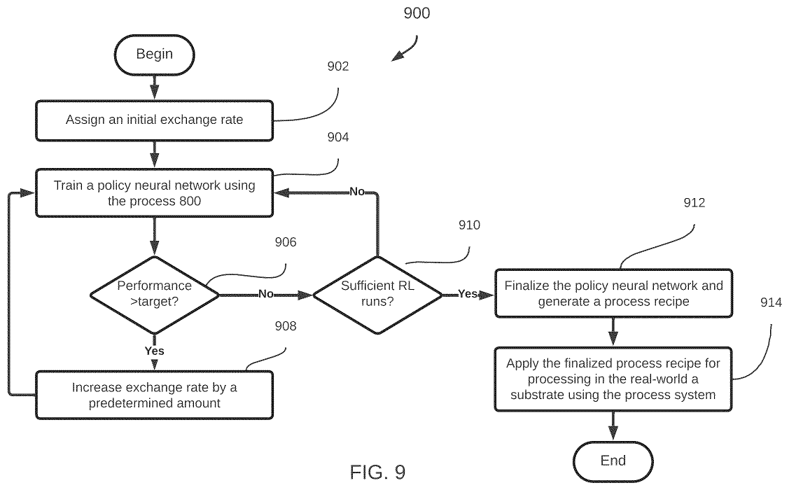

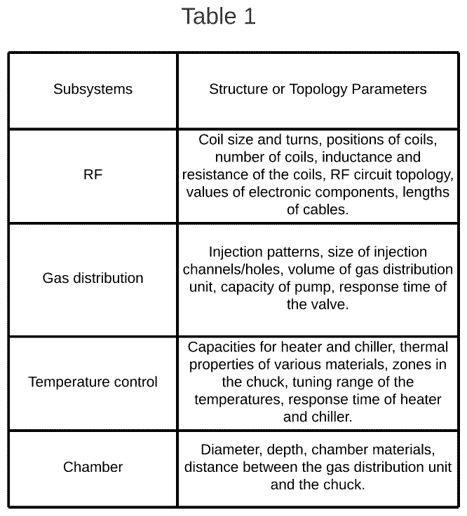

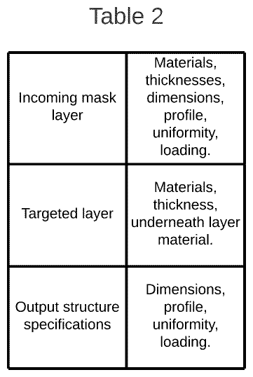

FIG. 9 showcases a flowchart of a process for minimizing the recipe time while meeting output specifications for the structure parameters. Process 900 starts with step 902, where an initial exchange rate is assigned by the RL agent 224. The exchange rate converts the second reward to the first reward. The initial exchange rate may start from a low value. In step 904, the policy neural network 226 is trained, and a process recipe is generated accordingly by applying process 800. In step 906, the RL agent 224 evaluates if the structure parameters have met the output specifications. If the result is positive, in step 908, the RL agent 224 increases the exchange rate and repeats process 800. The process continues until the performance of the output structures fails to meet the specifications. Subsequently, in step 910, the RL agent evaluates if the policy neural network 226 has undergone sufficient learning. If it has, the policy neural network 226 can be finalized based on the last RL process and a process recipe can be generated in step 912. Otherwise, the RL agent continues the learning process. In step 914, the finalized process recipe is deployed in the real world for processing a substrate in the process system.

1. A method for generating a process recipe for a semiconductor process system, comprising:
a) initiating by an AI engine an RL process for establishing a process recipe for the process system, wherein the RL process further includes generating a plurality of simulated process cases using a policy neural network and a MCTS program by leveraging a system digital twin;
b) generating a total reward for each simulated case, wherein the total reward further includes a first reward computed by a performance reward calculator and a second reward computed by a recipe time reward calculator, wherein the second reward can be converted into the first reward using an exchange rate to generate the total reward;
c) updating weights of a policy neural network based on the total reward until changes of weights are lower than a target;
d) generating a process recipe based on the updated policy neural network; and
e) processing a substrate in real-world using the process system based on the generated process recipe.

2. The method of claim 1, wherein the policy neural network includes an input layer, a plurality of hidden layers, and an output layer, wherein the output layer further includes outputs describing softmax or logistic functions for generating probability distributions of discretized levels of selected process recipe parameters and selected step times.

3. The method of the claim 1, wherein an initial exchange rate is assigned by an AI agent of the AI engine and the exchange rate is increased progressively during the RL process to focus the process more on minimizing the recipe time.

4. The method of claim 1, wherein the method further includes establishing, by the AI engine, a node associated with a state and expanding the node into a network including a plurality of nodes consisting of a plurality of state-action pairs, wherein the state describes the substrate being processed and the action describes a step of the process recipe.

5. The method of claim 4, wherein the method further includes distributing the total reward to each state-action pair, wherein the weights of the policy neural network are updated according to the distributed total reward.

6. The method of claim 4, wherein the method further comprises an algorithm encouraging exploration rather than exploitation for the step times while an action is being generated, wherein the algorithm further includes an ε-greedy algorithm.

7. The method of claim 1, wherein the AI engine is a part of an AI machine which is coupled to a plurality of process systems through communication links.

8. The method of claim 1, wherein the AI engine is a part of a system controller of the process system.

9. The method of claim 1, wherein the system digital twin further includes digital twins comprising: a RF digital twin, a gas digital twin, and a temperature digital twin, a chamber plasma digital twin, a surface flux digital twin, and a process digital twin.

10. The method of claim 9, wherein at least some of the digital twins are trained neural networks.

11. The method of claim 1, wherein the process system further includes etching process system and deposition process systems.

12. An AI machine, comprising:
a plurality of hardware and software modules optimized for AI applications; and
an AI engine built upon the hardware and software modules, wherein the AI engine further comprises:
an RL engine comprising an RL agent for autonomously training a policy neural network through an RL process;
a system digital twin for generating a plurality of simulated process cases; and
an AI engine controller for coordinating operations of the AI engine,
wherein the RL agent applies a total reward generated from the plurality of the simulated process cases to update weights of the policy neural network to generate a process recipe.

13. The AI machine of claim 12, wherein the total reward is computed by the RL agent from a performance reward calculator and a recipe time reward calculator.

14. The AI machine of claim 13, wherein the reward computed from the recipe time reward calculator can be converted into the reward calculated from the performance reward calculator using an exchange rate.

15. The AI machine of claim 14, wherein the RL agent assigns an initial exchange rate and increases the exchange rate progressively during the RL learning process to focus the process more on minimizing the recipe time.

16. The AI machine of claim 12, wherein the total reward is calculated based on a cost function which is a summation of squared errors for normalized output parameters measured against normalized output specifications, and for normalized step times, wherein a weight is assigned to each term in the function.

17. The AI machine of claim 12, wherein the system digital twin further includes an RF digital twin, a gas digital twin, a temperature digital twin, a chamber plasma digital twin, a surface flux digital twin, and a process digital twin.

18. The AI machine of claim 17, wherein some of the digital twins further include trained neural networks.

19. The AI machine of claim 12, wherein the RL engine further includes a MCTS program which is utilized with the policy neural network to generate probability distributions of selected recipe parameters and selected step times.

20. The AI machine of claim 12, wherein the AI machine is coupled to a plurality of process systems through communication links, wherein the plurality of the process systems further includes etching and deposition process systems.
